(19) United States
(12) Patent Application Publication
(10) Pub. No.: US 2008/0123210 A1
(43) Pub. Date: May 29, 2008

(54) Handling synchronization errors potentially experienced by a storage device

(76) Inventors: Wei Zeng, San Diego, CA (US); Lan Lan, Davis, CA (US); Yuan X. Lee, San Jose, CA (US); Aleksandar Kavcic, Cambridge, MA (US)

Correspondence Address: HITACHI C/O WAGNER BLECHER LLP, 123 WESTRIDGE DRIVE, WATSONVILLE, CA, 95076, US

(21) Appl. No.: 11/593,856

(22) Filed: Nov. 6, 2006

(51) Int. Cl. G11B 5/09

(52) U.S. Cl. 360/51

(57) ABSTRACT

Embodiments of the present invention pertain to handling synchronization errors potentially experienced by a storage device. According to one embodiment, a system for handling synchronization errors potentially experienced by a storage device includes a joint detector and a decoder. The joint detector detects transmitted data. The joint detector also detects timing errors that potentially result from the transmission of the data. The joint detector communicates information about the transmitted data and the timing errors with the decoder iteratively in a loop to reduce the amount of the transmitted data that is lost.

### TECHNICAL FIELD

Embodiments of the present invention relate to writing data to a storage device and reading data from the storage device. More specifically, embodiments of the present invention relate to handling synchronization errors potentially experienced by a storage device.

### BACKGROUND

Data can be stored on storage devices, such as disk drives or optical storage channels. In order to properly write data to a storage device and read the data back from the storage device, it is important that the storage device be able to locate the data. A piece of data is written to a location on the storage device at a certain frequency. In order to read the same piece of data, the location of the data needs to be determined. If the location is determined accurately, then the frequency of what is read will match the frequency of the data that was written at that location.

In order to be competitive, companies that manufacture storage devices are trying to increase the density at which data can be stored on their storage devices. A higher density means that the bits of data are being stored closer and closer together on storage devices. The closer that bits of data are stored to each other, the more likely that their respective frequencies will interfere with a storage devices ability to read the bits of data. Signal to noise ratio (SNR) is a commonly used measurement for determining how well a storage device can read back data. Higher densities result in poorer SNRs.

Further, magnetic recording (and communications) channels suffer from misalignment between the write (transmitter) clock and the read (receiver) clock. Receivers associated with conventional timing recovery systems, not being ideal, produce synchronization errors (or timing errors). Conventionally designed detectors/decoders at the receiver assume perfect synchronization from the timing recover devices. This assumption is reasonable when the system works at SNRs where the timing recovery devices work. However, at these low SNRs, conventional timing recovery devices typically fail.

### SUMMARY OF THE INVENTION

Embodiments of the present invention pertain to handling synchronization errors potentially experienced by a storage device. According to one embodiment, a system for handling synchronization errors potentially experienced by a storage device includes a joint detector and a decoder. The joint detector detects transmitted data. The joint detector also detects timing errors that potentially result from the transmission of the data. The joint detector communicates information about the transmitted data and the timing errors with the decoder iteratively in a loop to reduce the amount of the transmitted data that is lost.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 depicts a sampling (or A/D) system with timing errors, according to one embodiment.

FIG. 2 depicts a state-transition diagram of timing errors εₗ, according to one embodiment.

FIG. 3 shows a timing-error trellis column for Q=5 and lists the values P_{i,j} for all i that do not conform to equation 9, according to one embodiment.

FIG. 4 depicts a part of a joint (timing-error/ISI) trellis, according to one embodiment.

FIG. 5 depicts a system structure used for turbo equalization, according to one embodiment.

FIG. 6 depicts an iterative timing recovery system where timing recovery is performed multiple times, according to one embodiment.

FIG. 7 compares the bit error rate of the turbo equalization to when perfect timing recovery occurs, according to one embodiment.

FIG. 8 shows the BER performance of iterative timing recovery scheme by using forward-only soft-output detector proposed in Section II, according to one embodiment.

FIG. 9 illustrates the BER performance of iterative timing recovery by using the list-survivors forward-only detector proposed in Section III, according to one embodiment.

FIGS. 10-16 depict equations used in various embodiments of the present invention.

FIG. 17 depicts a part of a storage device receiver for handling synchronization errors potentially experienced by a storage device, according to one embodiment.

FIG. 18 depicts a block diagram of a data structure that includes a representation of data and a representation of timing errors, according to one embodiment.

The drawings referred to in this description should not be understood as being drawn to scale except if specifically noted.

### DETAILED DESCRIPTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

### Overview

At low SNRs, conventional timing recovery devices typically fail and channel decoders produce burst of decoding errors partly because the channel decoders assume that synchronization is perfect, which may not be the case. Therefore, according to one embodiment, detectors and decoders are designated to take possible timing uncertainties into account. For example, a discrete Markov model for the timing errors can be used, which led to a soft-output algorithm to jointly detect data symbols and timing errors. This soft-output detection algorithm, if concatenated with an iterative decodable code, can exchange extrinsic information with the error correcting decoder in an iterative (turbo) manner. According to one embodiment, this iterative approach is an “iterative timing recovery” which outperforms the turbo equalization schemes in terms of bit error rate (BER).

According to one embodiment, the iterative timing scheme is further refined to reduce the complexity and memory cost, while still achieving noticeable performance gain over the turbo equalization approach. For example, as will become more evident a forward only algorithm or a list-survivors forward-only algorithm can be used to modify the turbo equalization approach, according to various embodiments.

The following is a summary of the sections included herein: Section I reviews the channel and timing error model used by iterative timing recovery schemes. Section I starts with a discrete Markov timing error model, and then introduces an equivalent finite-state trellis mode. Sections II and III describe two refinements to the iterative timing scheme, according to various embodiments of the present invention. For example, Section II describes a forward-only detection algorithm that can also generate soft-output. This algorithm has much lower memory consumption as well as computational complexity than a forward-backward algorithm used by iterative timing recovery schemes. In section III, a list-survivors technique is described which can be used to reduce memory usage. Section IV describes iterative timing recovery schemes, according to various embodiments. Section V describes simulation results. Section VI provides a summary of various embodiments of the present invention.

### Section I: Source/Channel Model and Problem Formulation

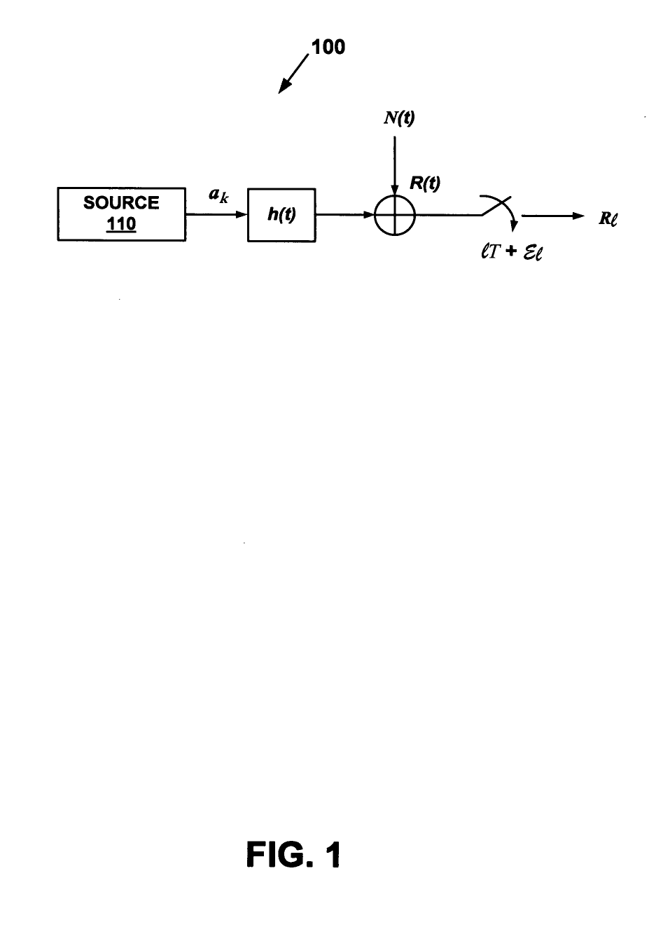

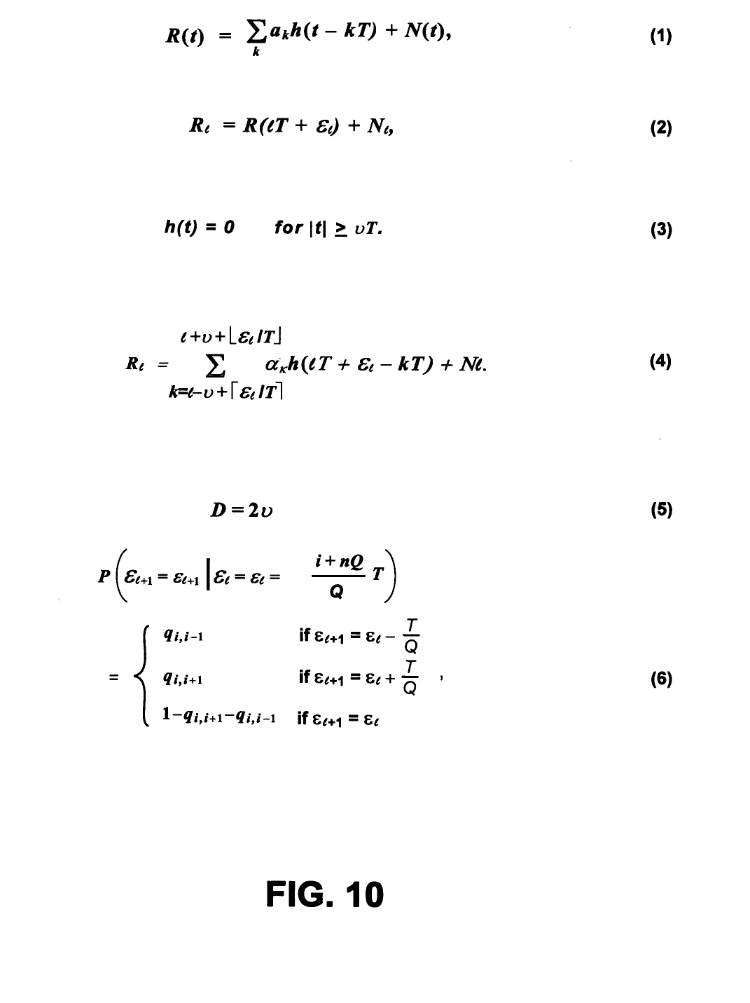

FIG. 1 depicts a system 100, according to one embodiment. For example, the binary antipodal written symbol (channel input symbol) from the source 110 is denoted at time k∈Z by aₖ∈{−1,+1}. The channel response function h(t) can be modulated by the input sequence {aₖ}. The read back waveform R(t) can have the form depicted in equation 1 of FIG. 10 where T is the symbol interval and N(t) is additive Gaussian noise.

An ideal receiver can sample the readback waveform R(t) at time instants T, 2T, 3T . . . . However, because of the timing errors, the receiver samples the readback waveform at the following sampling instants T+ε₁, 2T+ε₂, . . . , T+εₗ., and so on. That is, the l-th sample is as depicted in equation 2 (FIG. 10x) where Nₗ are independent and identically distributed Gaussian random variables with mean 0 and variance, shortly denoted by Nₗ˜N(0, σ²). For the sake of illustration, assume that Nₗ are independent of the input sequence {aₖ}. A generalization to a pattern-dependent noise, according to one embodiment, can be made.

For the purposes of illustration, assume that h(t) is a finite-support function that satisfies equation 3 depicted on FIG. 10. The support interval of h(t) can be denoted by (−v T, v T), where v∈Z⁺. By using equation 3 (FIG. 10), according to one embodiment, equation 2 (FIG. 10) can be rewritten as equation 4 depicted on FIG. 10. According to one embodiment, equation 4 shows that at most D=2 v data symbols are used to calculate the noiseless value of Rₗ . . . . For example, assume that the readback sample Rₗ falls inside the k-th symbol interval ((k−1)T, kT), the 2 v data symbols, according to one embodiment, that influence Rₗ are aₖ₋ᵥ, aₖ₋ᵥ₊₁, . . . , aₖ₊ᵥ₋₁.

Notational Conventions: Throughout the text, the following notational conventions are used. The probability of an event A is denoted by P(A). The probability of an event A, conditioned on an event B, is denoted by P(A/B). A sequence of variables bᵢ, bᵢ₊₁, . . . , bⱼ is shortly denoted by bᵢ^{j}. A readback sample Rₗ as depicted in equation 4 (FIG. 10) is a random variable, where its realization is denoted by rₗ. The positive integer K denotes the block length of written symbols (bits) a₁^{k}. The index k is exclusively used to count the written symbols (bits) aₖ, where 1≦k≦K. For a given block of input bits a₁^{k}, for the purposes of illustration L readback samples R^{L}₁ can be taken, whose realizations are r^{L}₁. Further assume for the purposes of illustration that index l (confined to 1≦l≦L) is exclusively used to count the readback samples Rₗ (or rₗ).

A. A practical physical model for the timing error

The timing error εₗ represents the difference between the sampling instant of the l -th sample of the readback waveform and the expected sampling instant lT, according to one embodiment. Since the writing process and the reading process are typically not perfectly synchronized, the timing error E t is a random process. In the conventional art, this random process is typically modeled as a constant for an extended number of bit intervals, or as a Gaussian random walk. Though such models are simple, they are often not accurate enough and do not provide enough parameters to tune the synchronizer.

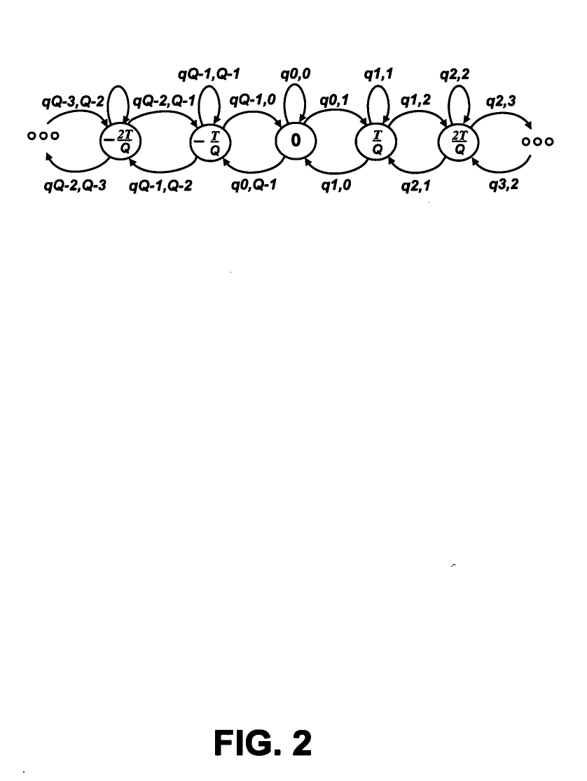

According to one embodiment, a timing error process model with several tunable parameters is used. According to another embodiment, the symbol interval is uniformly quantized into Q levels, and εₗ is allowed to take jT/Q, where j is an integer. The quantization is used as an approximation, which, if chosen to be fine enough, introduces only a marginally small quantization error, according to one embodiment. Further for the purposes of illustration assume that εₗ can be represented by a Markov process with the probability of transition from state iT/Q to state jT/Q denoted by q_{i,j}. FIG. 2 depicts a state-transition diagram of timing errors E t, according to one embodiment. FIG. 2 illustrates an example, where non-zero transition probabilities occur only between neighboring states, according to one embodiment. However, more accurate Markov models with transmissions between non-neighboring states are possible but are not considered here for the sake of simplifying illustrations herein. Note that due to the cyclostationarity of the timing error process, q_{i,j} equals q_{i+Q,j+Q}, according to one embodiment, resulting in equation 6 (FIG. 10) where iε{0, 1, . . . , Q−1} and n is an integer nεZ.

This discrete Markov model for the timing error process does not assume that the timing error is only a fraction of the bit interval, according to one embodiment. Rather, this discrete Markov model enables handling timing errors that are greater than the bit interval, i.e., the model allows cycle-slips to occur. Thus the model permits the design of advanced timing recovery loops and channel detectors that are resilient to cycle-slips.

For example, it is not hard to verify that, the number of possible values of the timing error εₗ grows linearly with time l. This can create problems, because the number of timing error states is unbounded as demonstrated by FIG. 2. According to one embodiment, this problem is circumvented by using an equivalent finite-state trellis model for the timing error process.

B. Equivalent Finite-State Trellis Model

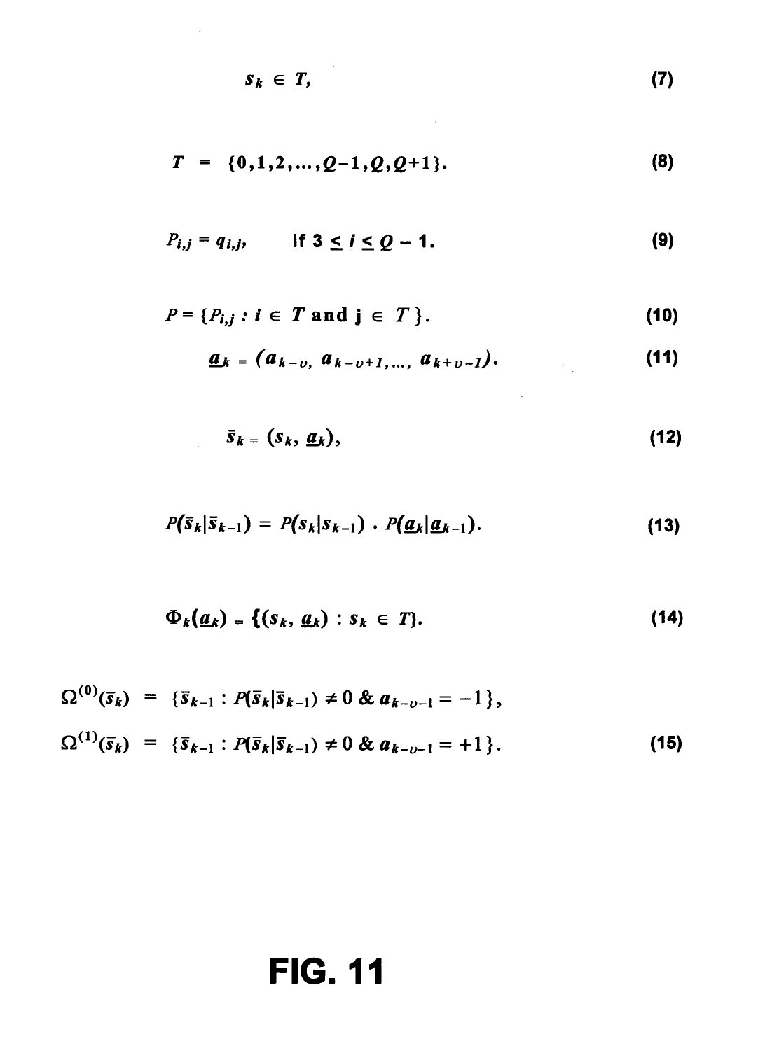

According to one embodiment, a state sₖ at time k is an element of the finite-size set Γ of all possible states as depicted in equation 7 (FIG. 11) where Γ={0, 1, 2, . . . , Q−1, Q, Q+1} as depicted in equation 8 (FIG. 11). A meaning is assigned to the elements of the set δ, according to one embodiment. For example, a state sₖ at time k is associated with the k-th symbol interval
((k−1) T, kT].
   The model depicted by equation 6 implies that one of the following three events will, according to one embodiment, occur depending on the realization of the timing error process:
   1) No sampling instant falls in the k-th symbol interval, according to one embodiment. For example, this event can be denoted by a state
sₖ=0.
   2) Exactly one sampling instant falls in the k-th symbol interval, according to another embodiment. For example, the value of this single sampling instant is confined to one of the Q possible quantized realizations (k-1)T+iT/Q, where iε subset {1, 2, . . . , Q}. Each of the quantized realizations can be denoted by a state
sₖ=i.
   3) Exactly two sampling instants fall in the k-th symbol interval, according to yet another embodiment. For example, these two sampling instants are

(k−1)T+T/Q and kT.

### This, for example, can be denoted by a state

sₖ=Q+1.

### According to one embodiment, the state sequence sₖεT is a homogenous Markov process with

P(sₖ|s₀^{k-1})=P(sₖ|sₖ₋₁).

denoted by P_{i,j} the probability

.P_{i,j}=P(sₖ=j|sₖ₋₁=i)

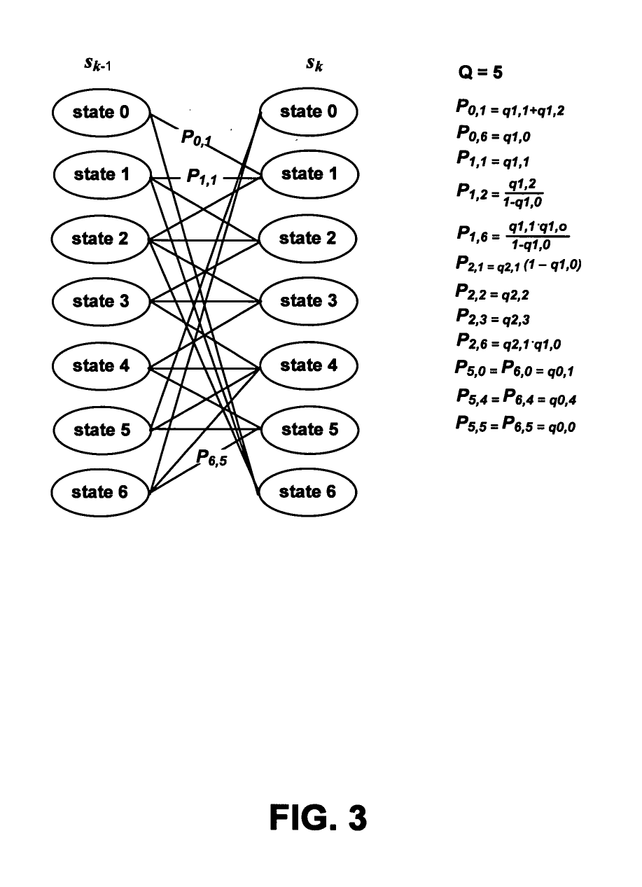

The values P_{i,j} can be derived from the probabilities q_{i,j} described in section I-A for example. For 3≦i≦Q−1, according to one embodiment the probabilities P_{i,j} are as depicted in equation 9 (FIG. 11). However, there are special cases that do not obey equation 9 depicted above and are handled with care, according to one embodiment. For example, FIG. 3 shows a trellis column for Q=5 and lists the values P_{i,j} for all i that do not conform to equation 9, according to one embodiment.

The timing errors trellis can thus be described by the set of states δ and by the state transition probabilities P_{i,j}. The probabilities P_{i,j} represent the tunable parameters that describe the timing error process εₗ. For notational purposes, these parameters P_{i,j} are grouped into the parameter set P depicted by equation 10 (FIG. 11).

The trellis model for the timing error process is essentially a homogeneous finite-state Markov chain, according to one embodiment. There are various estimation techniques that can be applied to solve many problems associated with this finite-state Markov model, according to one embodiment. For example, maximum-a-posterior-probability symbol detection can be performed under timing uncertainty, or iterative timing recovery can be performed for example by calculating soft-outputs from a finite-state trellis model.

C. Joint Timing Error/ISI Trellis

As a part of designing a soft-output data detector for the channel described using equation 4, there are two unknown processes with memory that can be modeled: 1) the timing error process εₗ, and 2) the channel input process aₖ observed through an intersymbol interference (ISI) channel. As a part of modeling the two unknown processes a trellis representation of the joint timing-error/ISI process is built, according to one embodiment. For example, from the finite support assumption depicted by equation 3, at most D=2v data symbols are used, according to one embodiment, to calculate the value of each sample that falls inside the interval ((k−1)T,kT]. These data symbols are aₖ=(aₖ₋ᵥ, aₖ₋ᵥ₊₁, . . . aₖ₊ᵥ₋₁) which are also depicted in equation 11 (FIG. 11).

Therefore the joint state s̅ₖ according to one embodiment is defined by equation 12 (FIG. 11) where B is the set of binary vectors of length 2 v. The resulting trellis according to one embodiment has (Q+2)×2^{2v} states, which jointly characterize the timing uncertainty and channel ISI. Each valid path through this joint trellis according to one embodiment uniquely determines a data sequence and a timing error sequence. Conversely, given a valid timing error sequence and a data sequence, a corresponding unique path can be found in the trellis, according to one embodiment.

Since the joint state s̅ₖ contains two independent parts:

(1) the timing state sₖ∈Γ and

(2) the ISI state aₖ=aₖ₋ᵥ^{k+v-1}∈B,

the state transition probability for the joint trellis is represented by equation 13 (FIG. 11).

The joint states in each trellis column can be partitioned into clusters according to their corresponding ISI state, according to one embodiment, such that the states in each cluster have the same ISI state, but different timing state. That is, the cluster for each ISI state aₖ in the k-th trellis column is defined to be equation 14 (FIG. 11). Each state s̅ₖ in the k-th trellis column of the joint trellis has some “parent states” s̅ₖ₋₁ in the (k−1)-th trellis column, such that P( s̅ₖ| s̅ₖ₋₁)≠0, according to one embodiment. For example, the set of “parent states” for a given state s̅ₖ, can be partitioned into two parent sets as depicted by equation 15 (FIG. 11).

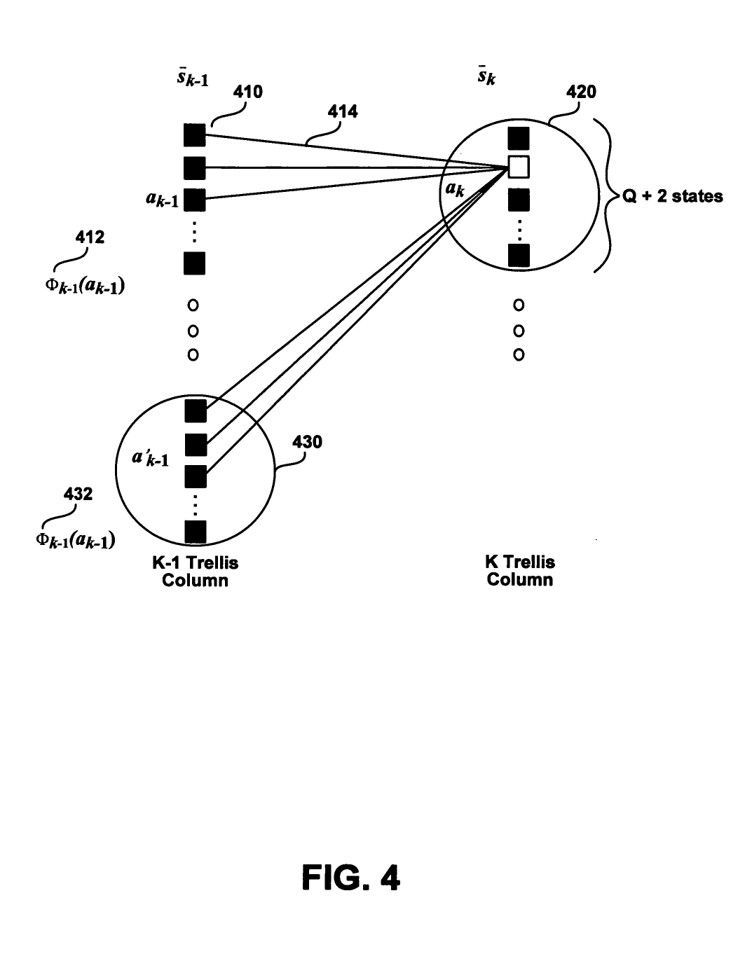

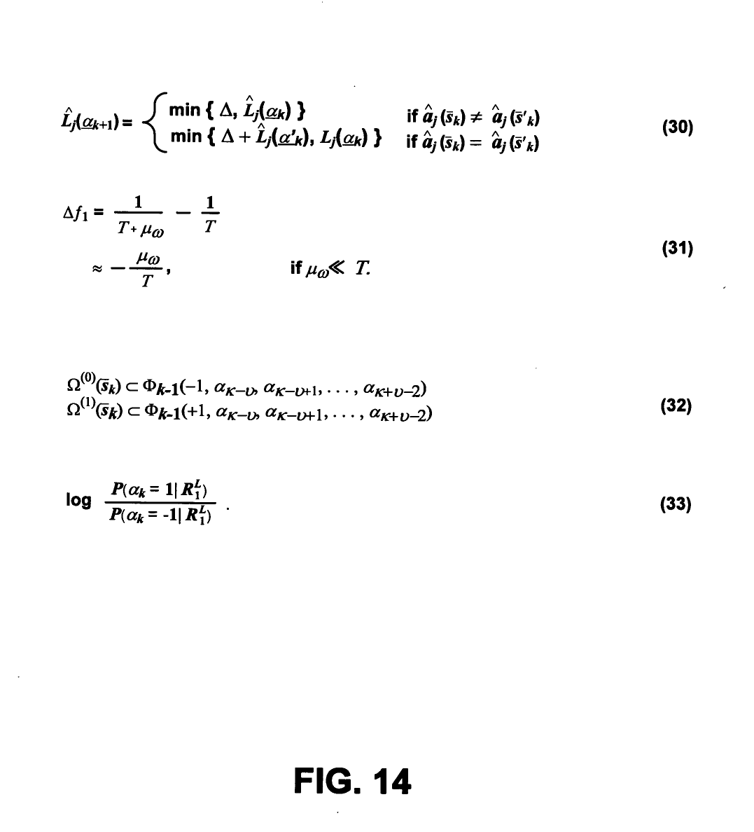

The first parent set Ω⁽⁰⁾ represents the set of parent states whose last ISI symbol is −1, and the parent set Ω⁽¹⁾ represents the set of parent states whose last ISI symbol is +1. All the states s̅ₖ₋₁ in each parent, according to one embodiment, have the same ISI information aₖ₋₁, but different timing error information s̅ₖ₋₁. The ISI states of the two parent sets represent the two parent states of aₖ in the ISI trellis, respectively. FIG. 4 depicts a part of a trellis, according to one embodiment. For example, FIG. 4 illustrates a structure represented by equation 32 (FIG. 14). As will become more evident, the parent states have been partitioned into two clusters 410 and 430 where states, as represented by the squares, in each cluster have the same ISI information.

### Section II. a Forward-Only Algorithm

In this section, a forward-only detection algorithm for generating soft-output for each transmitted symbol, according to one embodiment, is described. That is, for each transmitted symbol aₖ, the value (or a good approximation) of the log-likelihood ratio can be computed using equation 33 depicted on FIG. 14. Each of the clusters 410, 420, 430 include representations of data and representations of timing errors. The squares represent the joint state and the Φ symbols represent the set of states with the same ISI information (data). For example, the cluster 410 includes many squares that represent the same ISI data aₖ₋₁ but different timing errors.

The clusters 410, 420, 430 are organized according to time. For example, cluster 410 and 430 occurred at time k−1 and cluster 420 occurred at time k. As depicted in FIG. 4, the clusters 410 and 430 are the parents of cluster 420. Lines (also commonly called “edges”) between the states (this can be timing-error states or joint states), such as line 414, represent a possible transmission between two states. For example in FIG. 4 if there is a line between a square in k−1 trellis column and a square in the k trellis column the corresponding state transmission is possible. According to one embodiment, ISI information is represented by the data.

According to one embodiment, the data structure that includes representations of transmitted data and timing errors is a trellis. For example, the data structure depicted in FIG. 4 is a trellis. A trellis is a Markov chain. At a given time k−1 the communication channel can be represented by a unique state sₖ₋₁. After the next transmission the channel can be represented by another state sₖ. In this illustration, k−1 and k represent the time index of the transmission. At each step k the channel can be presented by a finite number of states. For example, sₖ has a finite alphabet. The whole transmission can be represented by a sequence of channel states s1 s2 s3 to sn . . . . The states can be extended into time. The channel states along the time axis is a trellis, according to one embodiment.

A. Storage at Step k

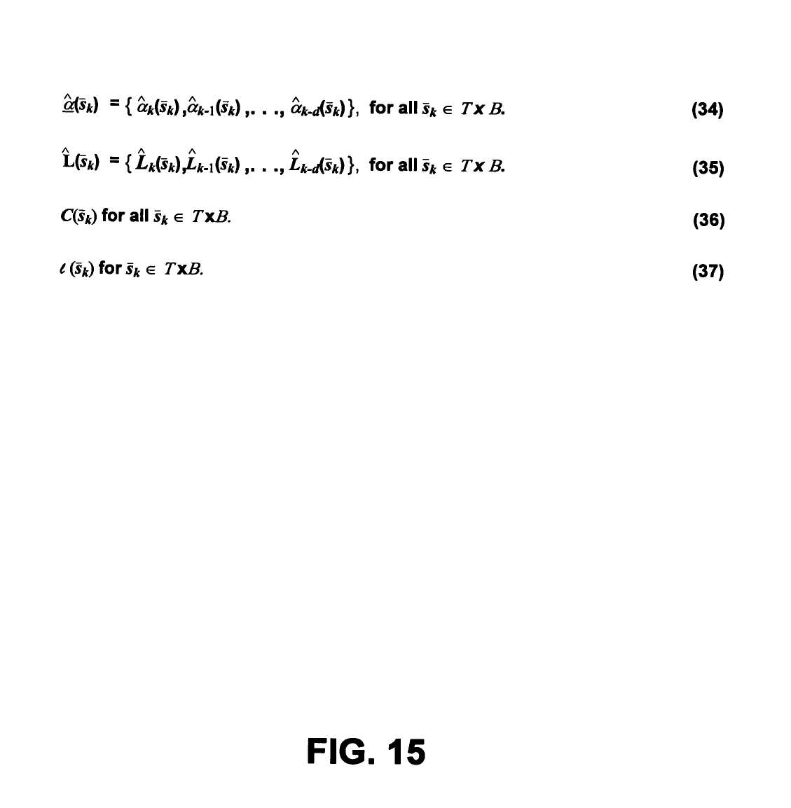

According to one embodiment, a type modified soft-output Viterbi algorithm (SOVA) that utilizes the trellis structure described in Section I is used. For example, assume that the algorithm has a detection delay (or decoding window) size d. At each detection step k, the following can be stored:
1) The most recent hard decision values (or the survivor path) as depicted by equation 34 (FIG. 15).
2) Soft reliability for the most recent bits as depicted by equation 35 (FIG. 15).
3) The accumulative metric value for each state as depicted by equation 36 (FIG. 15).
4) The most likely number of received samples within the first k bit intervals (0, kT] as depicted by equation 17 (FIG. 15).

The storage for the number of received samples l( s̅ₖ) does not appear in conventional SOVA, however, an algorithm according to one embodiment of the present invention takes into account the possible cycle-slips.

B. Branch Metric Computation

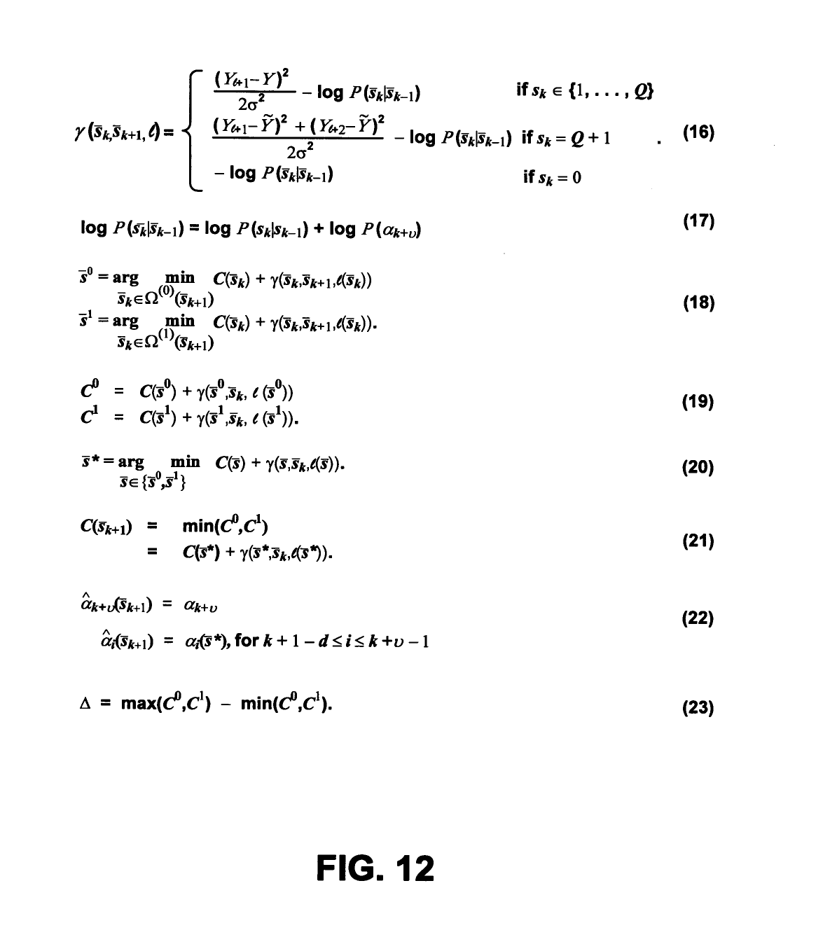

The branch metric function γ( s̅ₖ, s̅ₖ₊₁, l( s̅ₖ)) for a valid state transition ( s̅ₖ, s̅ₖ₊₁) in the joint trellis is denoted, according to one embodiment, by equation 16 (FIG. 12) where \tilde{Y} represents the noiseless output corresponding to the given trellis branch. The trellis state transition probability is given by equation 13 (FIG. 11), and can be computed using equation 17 (FIG. 12).

C. Recursion at Step (k+1)

At the detection step (k+1), for each s̅ₖ₊₁, a survivor from each of the two clusters of parent states is picked. That is, for each s̅+ₖ₊₁∈Γ×B, s̅⁰ and s̅¹ are picked as indicated by equation 18 (FIG. 12). The accumulative metric value of these two survivor states are computed, according to one embodiment, from the two parent clusters C⁰ and C¹, respectively as indicated by equation 19 (FIG. 12). According to one embodiment, the state with the smallest accumulative metric value is chosen from s̅⁰ and s̅¹ using equation 20 (FIG. 12).

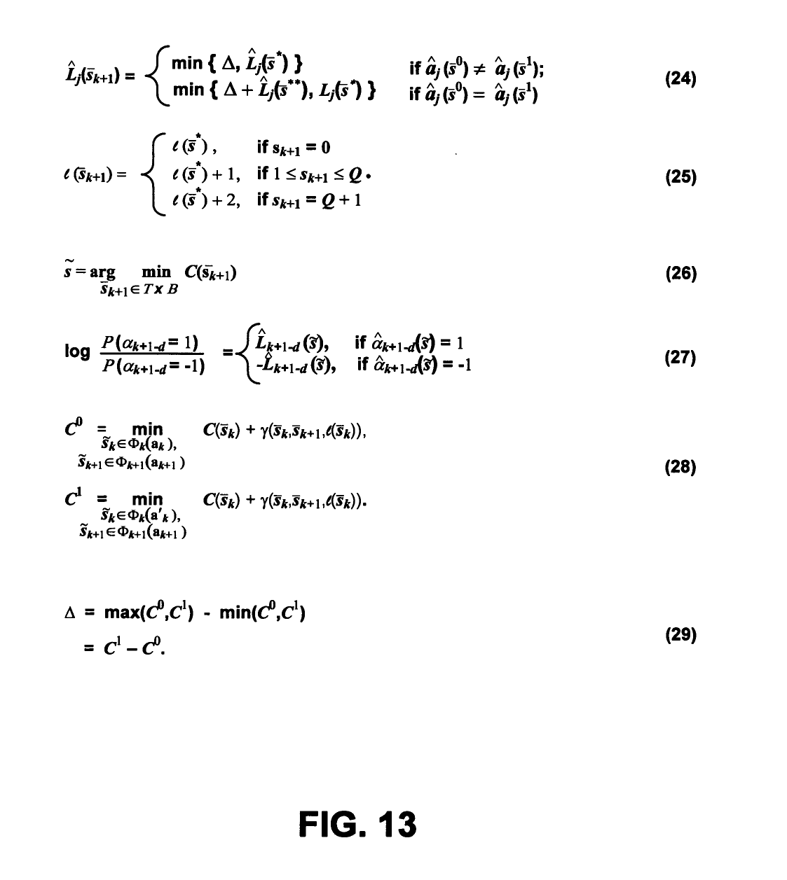

The accumulative metric value for state s̅ₖ₊₁ is updated, according to one embodiment, as indicated by equation 21 (FIG. 12). The survivor path of state s̅ₖ₊₁ is updated, according to one embodiment, as indicated by equation 22 (FIG. 12). According to one embodiment, the definition represented by equation 23 (FIG. 12) is used. The soft reliability values for states s̅ₖ₊₁ are according to one embodiment updated as indicated by equation 24 (FIG. 13) fork+1−d<i<k+v−1, where s̅** is the non-survivor state in s̅⁰, s̅¹, and s̅** is the survivor state. Finally, the value of the number of received samples corresponding to state s̅ₖ₊₁ is updated according to one embodiment as indicated by equation 25 (FIG. 13).

The above procedures in (18)-(25) are repeated for each s̅ₖ₊₁∈Γ×B, according to one embodiment. At the end of step k+1 recursion, the detector outputs the soft values (log-likelihood-ratio) for the input symbol a_{k+1-d} with a fixed delay d, according to one embodiment. Assume for the sake of illustration, that equation 26 (FIG. 13) is the state with minimum accumulative metric at step k+1. Therefore, according to one embodiment, the output of the detector can be computed using equation 27 (FIG. 13). Most of the computation in this forward-only detection algorithm consists of only addition (or comparison) operations, except the branch metric computation in equation 16 where multiplication is used. Notice that log( s̅ₖ| s̅ₖ₋₁) were computed by using table lookup, according to one embodiment.

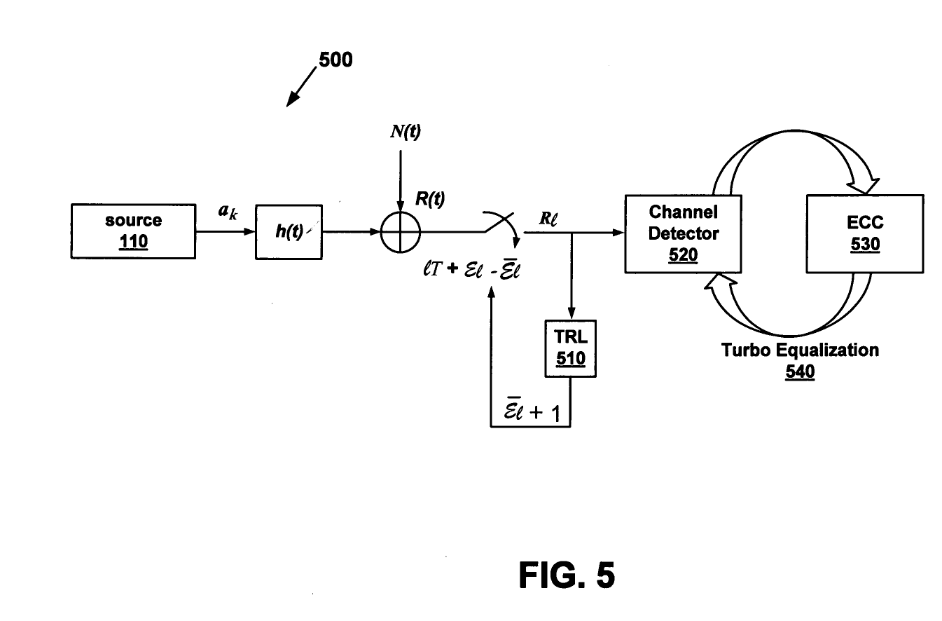

This forward-only algorithm, according to one embodiment, uses much less memory consumption than the forward-backward algorithm used by turbo equalization system 500 depicted in FIG. 5 for example. For example, according to one embodiment, the amount of memory used by the forward-only algorithm is independent of the block length. However, according to one embodiment the number of states in each trellis column is (Q+2) times the number of state in an ISI trellis. Although the forward-only algorithm according to one embodiment addresses the issue of timing errors it can lead to larger computational complexity than the conventional soft-output algorithm for channel with ISI especially for large Q. Therefore, in the next section III a list-survivors forward-only algorithm, according to one embodiment, is described. As will become more evident, the list-survivors forward-only algorithm provides reduced memory and computational costs, for example, by keeping the trellis-size and computational complexity independent of the Q.

### Section IV. a List-Survivors Forward-Only Algorithm

According to one embodiment, the memory cost and computational complexity of the forward-only algorithm is due to the fact that there are large numbers of states in the joint trellis. Each cluster, as defined by equation 14, contains Q+2 states,

The list-survivors forward-only algorithm described in this section can be implemented, according to various embodiments, using one or more of the following ideas:

1) At the end of each trellis propagation, only the most likely J states in each cluster are kept and the other (small probability) states are ignored, where 1≦J≦(Q+2). For example, if J is small (say J=2), then the resulting memory cost is small.

2) Instead of computing (and storing) the soft reliability \hat{L}ⱼ for each state s̅ₖ, only the soft reliability for each cluster (or each ISI state) is computed (and stored).

A. Storage at Step k

Assume for the sake of illustration that the algorithm has a detection delay (or decoding window) size d. At each detection step k, the following are stored according to various embodiments:

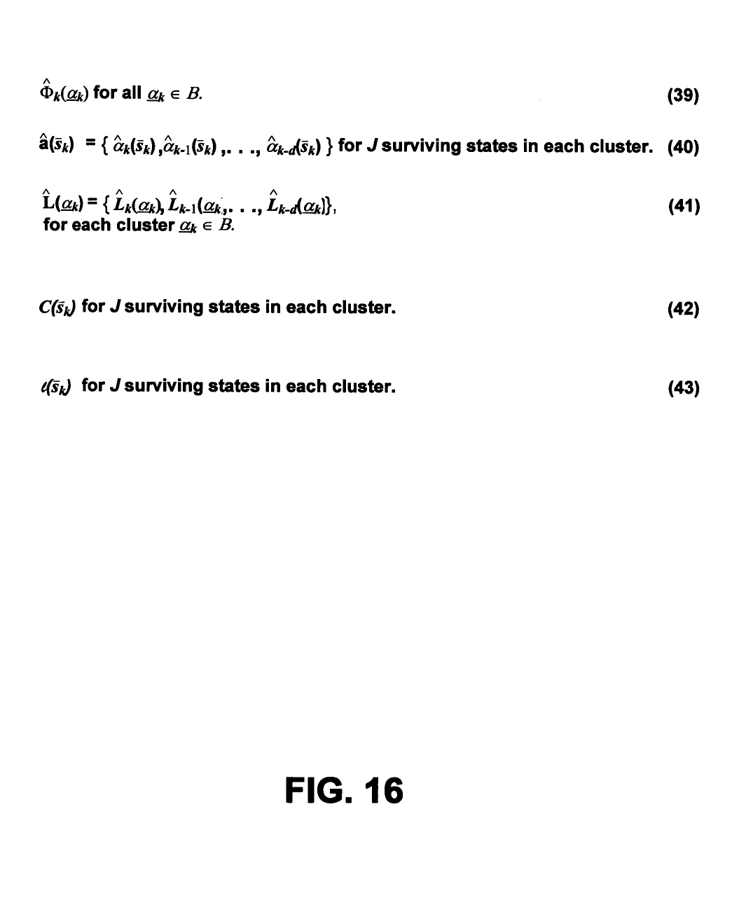

1) The set of J surviving states in each cluster Φₖ(aₖ) as represented by equation 39 (FIG. 16).

2) The most recent hard decision values as represented by equation 40 (FIG. 16).

3) Soft reliability of the most recent bits as represented by equation 41 (FIG. 16).

4) The accumulative metric value as represented by equation 42 (FIG. 16).

5) The most likely number of received samples within the first k bit intervals (0, kT))as represented by equation 43 (FIG. 16).

B. Recursion at Step (k+1)

At the detection step (k+1), according to one embodiment, only the accumulative metric for those states s̅ₖ₊₁ are updated that have at least one parent state surviving in step k. For example, the accumulative state metric can be updated in the same way as the forward-only algorithm, by using (18)-(21). However, according to one embodiment, the parent sets ω⁽⁰⁾ and ω⁽¹⁾ contain only the surviving parent states. For the purpose of illustration assume the parent states contain only the surviving parent states for this section, without explicitly changing the notation from the previous section. In the case where one of the parent sets is empty, say, ω⁽⁰⁾=φ, set s̅*= s̅¹ in equation 20 (FIG. 12), according to one embodiment. Notice that when J is small, the accumulative metric according to one embodiment is updated for only a small number of states s̅ₖ₊₁ out of the 2²^{ᵥ}·x(Q+2) states in the (k+)-th trellis column.

After the accumulative metrics are updated for states in the (k+1)-th trellis column, only J surviving states (with smallest metrics) are kept in each cluster, according to one embodiment. For example, the other states are discarded. For each of these surviving states s̅ₖ₊₁ respective hard decision values â( s̅ₖ₊₁) are updated using equation 22 (FIG. 12) according to one embodiment, and l(sₖ₊₁) is updated using equation 25 (FIG. 13) according to another embodiment, for example in a similar way as the forward-only algorithm.

The soft reliability update, according to one embodiment, is slightly different from the forward-only algorithm. For example, the soft reliability for each cluster Φₖ₊₁(aₖ₊₁) can be computed instead for each state. For the purpose of illustration, consider the cluster with ISI state aₖ₊₁=(aₖ₋ᵥ₊₁, aₖ₋ᵥ₊₂, . . . , aₖ₊ᵥ), the two parent clusters in the k-th trellis column have ISI state

aₖ=(−1, aₖ₋ᵥ₊₁, aₖ₋ᵥ₊₂, . . . , aₖ₊ᵥ₋₁) and aₖ′=(+1, a_{k-v+1, a}ₖ₋ᵥ₊₂, . . . , aₖ₊ᵥ₋₁), respectively. Equation 28 (FIG. 13) can be used to define C⁰ and C¹.

Without loss of generality, C⁰ can be assumed to be the accumulative metric of the path containing P and C¹ can be assumed to be the accumulative metric of the path containing ( s̅ₖ, s̅ₖ₊₁) respectively For the purpose of illustration, assume C⁰<C¹. Equation 29 (FIG. 13) can be used to define Δ.

The soft reliability for the cluster is, according to one embodiment, updated as indicated by equation 30 (FIG. 14) where aₖ and aₖ′ are the corresponding ISI state of s̅ₖ and s̅ₖ′, respectively.

### Section V. Iterative Timing Recovery Schemes

FIG. 5 depicts a system structure used for turbo equalization, according to one embodiment. FIG. 5 includes, among other things, a timing recovery loop 510, a channel detector 520, and an ECC 530. Turbo equalization 540 can be performed between the channel detector 520 and the ECC 530, as depicted in FIG. 5. The turbo equalization system 500 depicted in FIG. 5 performs timing recovery once without any help from the decoder.

The turbo equalization is based on the notion that soft information need not only flow in one direction. According to one embodiment, after the decoder receives and processes soft information from the (soft-output) channel detector, it can generate its own soft information of each transmitted symbol. This soft information from the decoder can then be fed back to the channel detector to further improve the detection (or equalization) process. Therefore, according to one embodiment, the channel detector 522 and the decoder 530 form a feedback loop 540, through which they pass the beliefs about the relative likelihood that each symbol takes on a particular value. Such a process can also be referred to as belief propagation or message passing, and has shown remarkable performance gains.

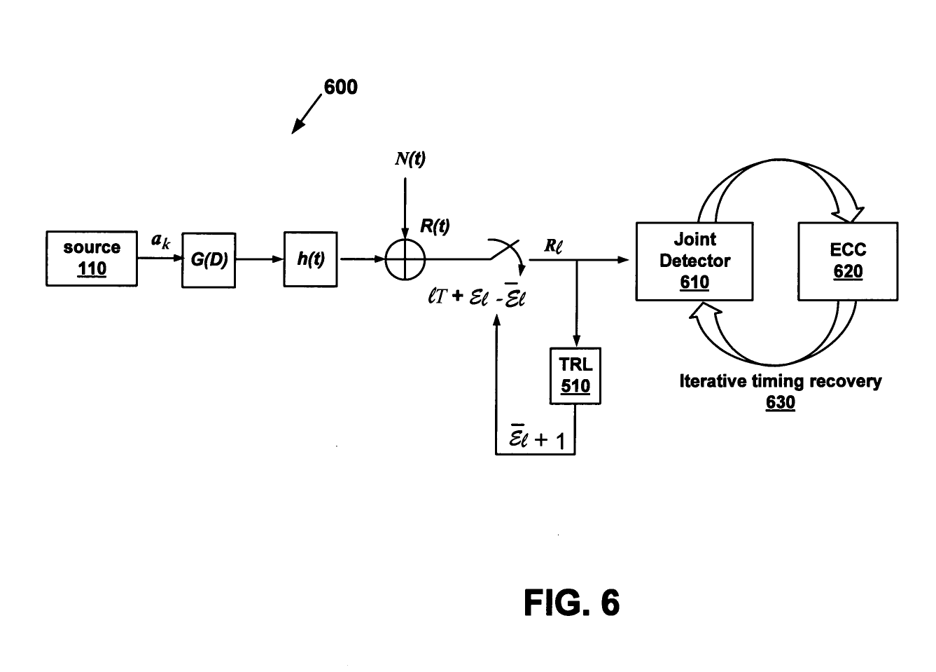

In contrast, according to one embodiment, FIG. 6 depicts an iterative timing recovery system 600 where timing recovery is performed multiple times, as indicated by the arrows 630, while interacting with the decoder 620, referred to herein as “iterative timing recovery.” For example, iterative timing recovery can be used in combination with interacting with the decoder 620.

The iterative timing recovery 630 modifies the turbo equalization loop 540, according to one embodiment, by incorporating the timing recovery procedures inside the turbo equalization loop. One way to implement such iterative timing recovery scheme is to replace the channel detector 520 that only compensates for ISI with a detector 610 that jointly compensates for ISI and timing errors. Such a joint detector 610, according to one embodiment, could be implemented as a modification to a forward-backward detector 520. According to another embodiment, the joint detector 610 could be implemented as a forward-only detector as described in Section II. According to yet another embodiment, the joint detector 610 could be implemented as a list-survivors forward-only detector as described in Section III.

### VI. Simulations

This section V describes simulation results for iterative timing recovery schemes using two detection algorithms described in Section II and Section III. To assess the quality of the iterative timing recovery methods using the proposed soft-output detectors, both algorithms are compared to the turbo equalization with and without residual timing errors after the phase-locked loop. For the simulations, the data symbols were generated by an equiprobable binary, and are independent and identically distributed (i.i.d.). The symbols are first passed through the filter G(D)=1−D², as shown in FIG. 6. Assume for the purpose of illustration that h(t) is a truncated sin c(·) function of the form h(t)=sin c(t/T)[u(t+T)−u(t−T)], where u(t) is the unit step function. If there is no timing error, the channel is equivalent to what is known as a PR4 channel which is described by P. Kabal and S. Pasupathy in “Partial-response signaling,” IEEE Trans. Communications, vol. 12, no. 9, pp. 921-934, September 1975.

In the simulations, waveforms were created according to equation 1 (FIG. 10), wherein the timing error {εₗ} injected into the waveform is a Gaussian independent increment process εₗ=εₗ₋₁+Wₗ and Wₗ˜N(μ₁₀₇ T, σ²_{w}T²) are i.i.d. Gaussian random variables. Therefore, according to one embodiment, this timing error process has a frequency offset as indicated by equation 31 (FIG. 14). For the purpose of designing the soft-output detector for this timing error, the timing error was approximated by the model depicted in equation 6 (FIG. 10), however, with the simplification q_{i,j}=a for all |i−j|=1 and q_{i,i}=1-2q, according to one embodiment.

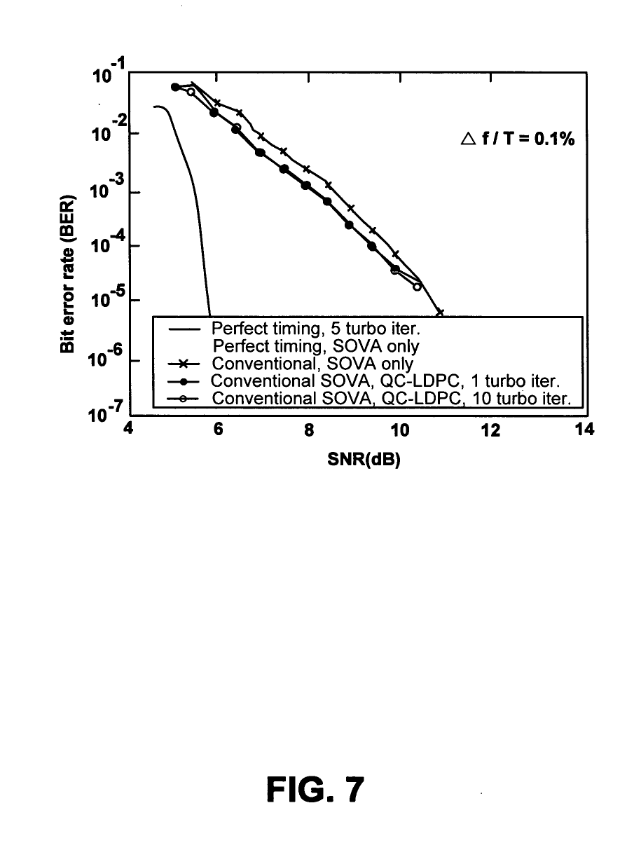

FIG. 7 compares the bit error rate of the turbo equalization to when perfect timing recovery occurs, according to one embodiment. The original timing error injected into the system for this simulation had a mean μ_{w}=1.0% and a variance σ_{w}=0. For the cases where perfect timing recovery was not assumed, a second-order PLL with M&M detector was used as the timing error detector. The first and second order loop coefficients were set to α=0.012 and β=8×10⁻⁶. The code is quasi-cyclic low density parity check code (QC-LDPC) with rate 0.917.

The results of the simulation indicated that when there is no timing error (perfect timing recovery), BER is greatly reduced as the number of iterations increased in turbo equalization. However, when there is timing error, there is almost no visible performance gain in BER as the number of turbo equalization iterations increased from 1 to 10. Further, the results of the simulation indicated that performance of the coded system is not much better than the un-coded system, according to one embodiment.

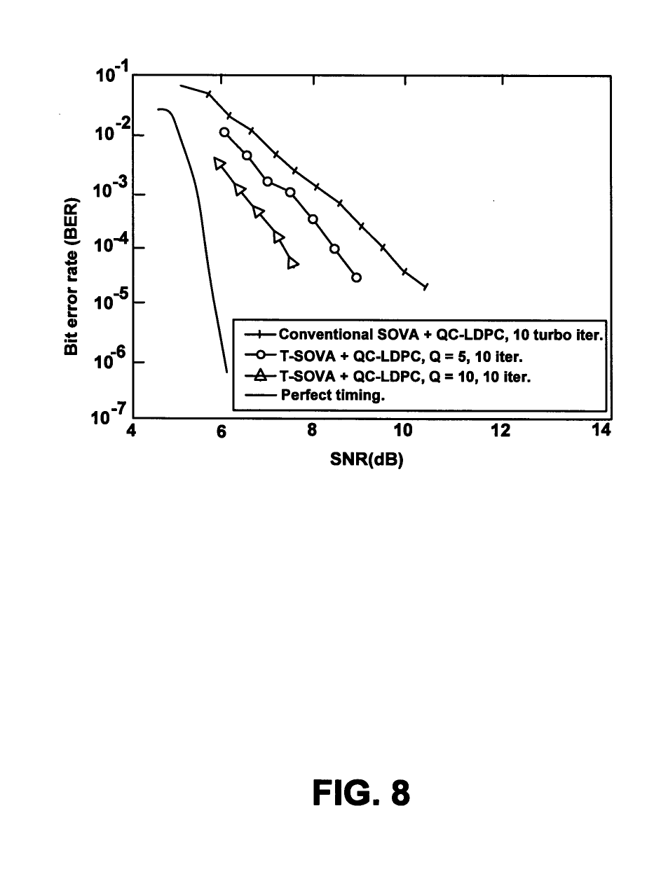

FIG. 8 shows the BER performance of iterative timing recovery scheme by using forward-only soft-output detector proposed in Section I, according to one embodiment. For the purpose of illustration, the experiment setups are the same as that in FIG. 7. The simulation results indicated that the iterative timing recovery method provide large performance gain in BER compared to the turbo equalization. Further, the results indicated that when the number of quantization level was increased from Q=5 to Q=10, the BER decreases.

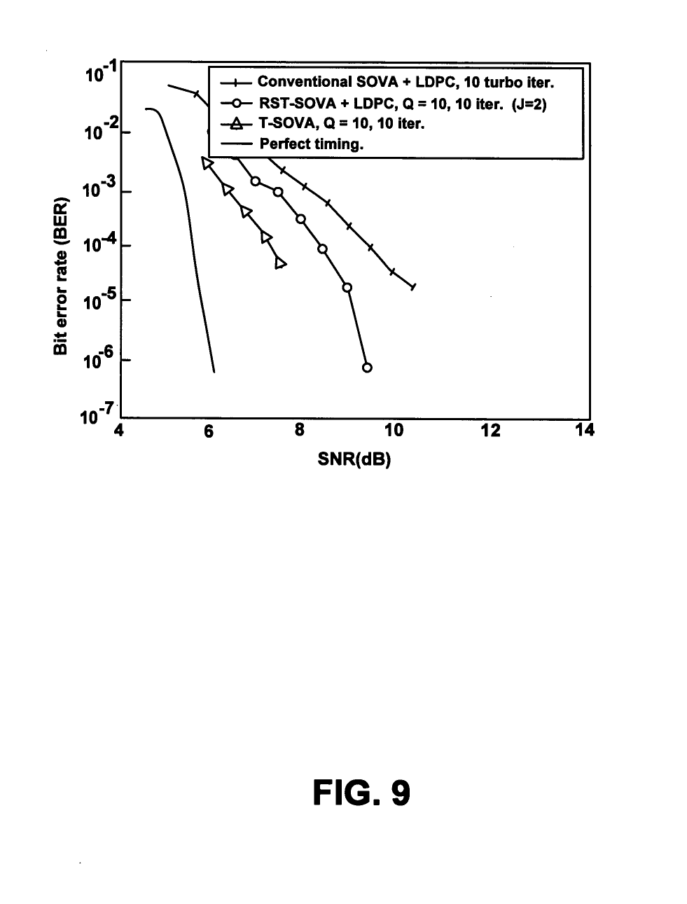

FIG. 9 illustrates the BER performance of iterative timing recovery by using the list-survivors forward-only detector proposed in Section III, according to one embodiment. For the purpose of illustration, the experiment setups are the same as that in FIG. 7. The number of quantization level is set to Q=10. For each cluster only J=2 surviving states were kept. The simulation results indicated noticeable performance improvements in comparison to the turbo equalization. However, the list-survivors forward-only detector embodiment, described in Section III, did not perform quite as well as the forward-only algorithm embodiment, described in Section III, with the same number of quantization levels. However the memory cost and computational complexity were greatly reduced using the list-survivors forward-only detector embodiment.

### VI. Summary

As already stated, as density increases the amount of interference between pieces of data stored on a storage device increases. Conventional systems are prone to losing data because, among other things, their channel detectors assume that the timing error recover loop 510 has done a perfect job of recovering. For example, conventional channel detectors do not take into account residual timing errors because conventional channel detectors assume that the difference between the actual timing errors and estimated timing errors is zero.

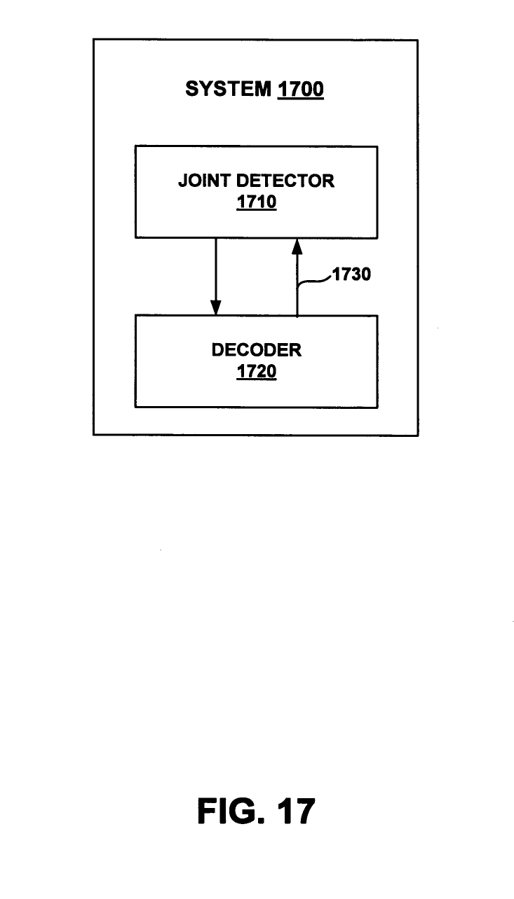

FIG. 17 depicts a part of a storage device receiver for handling synchronization errors potentially experienced by the storage device, according to one embodiment. According to one embodiment, system 1700 is a part of a storage device receiver for handling synchronization errors potentially experienced by the storage device. According to one embodiment, data (also known as a “signal”) is written to a disk associated with the storage device. The writing of data to the disk is also commonly known as a “transmission process.” The data can then be read from the disk. Reading the data from the disk is also commonly known as a “receiving process.” Timing errors can occur if the speed of writing and the speed of reading the data do not match, which can lead to errors in detecting what data is stored on the disk. According to one embodiment, the system 1700 is used as a part of correctly detecting what is stored on the disk even if timing errors occur. For example, the system 1700 does not assume that the timing error recovery loop 510 has done a perfect job of recovering, according to one embodiment. The system 1700 includes a joint detector 1710 and a decoder 1720. According to one embodiment, the joint detector 610 is an example of a joint detector 1710 (FIG. 17). Further, according to one embodiment, the ECC 620 is an example of a decoder 1720.

According to one embodiment, the joint detector 1710 detects transmitted data and timing errors. In contrast to the joint detector 1710, a conventional channel detector only detects transmitted data. According to another embodiment, the joint detector 1710 communicates information about the transmitted data and the timing errors with the decoder 1720 iteratively in a loop 1730 to reduce the amount of lost data. For example, various embodiments increase the probability of recovering from timing errors even if the timing recover loop 510 has done an insufficient job of recovering. According to one embodiment, the iterative timing recovery 630 is an example of the loop 1730.

The joint detector 1710 uses a forward-only algorithm, according to one embodiment. Section II describes the forward-only algorithm, according to various embodiments. The joint detector 1710 uses a list-survivors forward-only algorithm, according to another embodiment. Section III describes the list-survivors forward-only algorithm, according to various embodiments. According to one embodiment, the channel detector only uses the states that survive based on an accumulative metric as parents for generating states for a subsequent sample of data, for example, as described in Section III.

According to one embodiment, a trellis is used to represent the information about the transmitted data and the timing errors. FIG. 4 depicts a portion of a trellis that can be used according to one embodiment.

According to one embodiment, the system 1700 stores information such as the information described in Section II-A. According to another embodiment, the system 1700 stores information such as the information described in Section III-A.

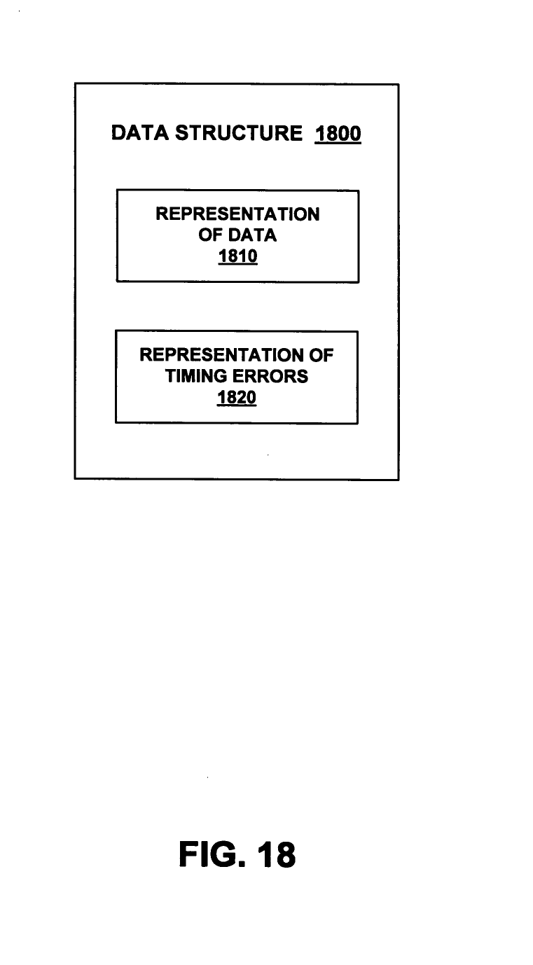

FIG. 18 depicts a block diagram of a data structure 1800 that includes a representation of data and a representation of timing errors, according to one embodiment. The data is transmitted, for example by writing the data to the storage device or by reading the stored data from the storage device, using a storage device and the timing errors resulted from the transmission of the data, according to one embodiment. The joint detector 1710 and the decoder 1720 use the data structure to communicate iteratively 1730 with each other in order to reduce the amount of data that is lost.

According to another embodiment, the information about the transmitted data and the timing errors are represented by a trellis. FIG. 4 depicts a part of a trellis, according to one embodiment, that includes information about transmitted data and the timing errors. A trellis such as the one depicted in FIG. 4 is also referred to as a “joint trellis” because it includes information about transmitted data and timing errors. FIG. 3 depicts a section of a timing error trellis that can be incorporated into a joint trellis. In contrast, conventional systems use a trellis that only includes information about transmitted data.

According to one embodiment, a system 1700 for handling synchronization errors uses the data structure 1800 to reduce the amount of the data that is lost by improving synchronization performed by a timing recovery loop 510. For example, as already explained herein, typically a channel detector associated with a conventional a system is prone to losing data because, among other things, their channel detectors assume that the timing error recovery loop 510 has done a perfect job of recovering. For example, a conventional channel detector does not take into account residual timing errors because the conventional channel detector assumes that the difference between the actual timing errors and estimated timing errors is zero. According to one embodiment, a system 1700 does not assume that the difference between the actual timing errors and estimated timing errors is zero for example by using a data structure 1800 to communicate between a joint detector 1710 and a decoder 1720.

In conclusion, various embodiments of the present invention provide the following:
(1) Backward recursion, according to one embodiment, is not required. Therefore, the detection process, according to one embodiment, does not have a processing delay comparable to the block (sector) length, as is the case with certain conventional detection systems;
(2) The detection algorithm, according to one embodiment, uses simple addition and comparison operations instead of a large number of exponential computations, as is the case with certain conventional detection systems. Therefore, the detection algorithm, according to one embodiment, provides for less complex computations than certain conventional detection systems;
(3) The list-survivors forward-only detector embodiment significantly reduces the amount of memory used in comparison to certain conventional detection systems.
(4) The forward-only embodiment reduces the number of previously computed state metrics that are stored in comparison to certain conventional detection systems.

There has been a long felt need for reducing or even eliminating loss of data. This has been true from the time the computers and storage devices first started being used up until the present time. Many customers have vital data that they cannot afford to loss. Further, customers do not want to deal with the hassles of losing data. Therefore, a storage device manufacturer that can provide as much reliability, by reducing or eliminating data loss, has a significant competitive edge. Any improvements in reliability position the manufacturer to increase their market share for selling storage devices.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments described herein were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A system for handling synchronization errors potentially experienced by a storage device, the system comprising:
a joint detector that detects transmitted data and timing errors that potentially result from the transmission of the data; and
a decoder, wherein the joint detector communicates information about the transmitted data and the timing errors with the decoder iteratively in a loop to reduce an amount of the transmitted data that is lost.

2. The system of claim 1, wherein the storage device is selected from a group consisting of a disk drive and an optical storage channel.

3. The system of claim 1, wherein the joint detector uses a forward-only algorithm.

4. The system of claim 3, wherein the system stores most recent hard decision values, soft reliability for most recent bits of data transmitted, accumulative metric values for each state of the timing errors, and most likely number of received samples within a bit interval of data.

5. The system of claim 1, wherein the joint detector only uses states that survive based on an accumulative metric as parents for generating states for a subsequent sample of data.

6. The system of claim 5, wherein the joint detector uses a list-survivors forward-only algorithm.

7. The system of claim 6, wherein the system stores a set of surviving states for a cluster of timing errors for a particular piece of data, wherein the surviving states are the parents for generating the states for the subsequent sample of data.

8. The system of claim 1, wherein a trellis is used to represent the information about the transmitted data and the timing errors.

9. A data structure that is used by a system for handling synchronization errors potentially experienced by with a storage device, the data structure comprising:
a representation of the data transmitted using the storage device; and
a representation of timing errors that potentially result from the transmission of the data, wherein a joint detector and a decoder associated with the storage device use the data structure to communicate iteratively with each other to reduce an amount of the data that is lost.

10. The data structure of claim 9, wherein the data structure is a trellis.

11. The data structure of claim 9, wherein the data structure further comprising:
a cluster for grouping timing errors for a particular piece of data together.

12. The data structure of claim 11, wherein the representation of timing errors include states and wherein the data structure further comprises:
a representation of a possible transition between a state associated with one cluster and a state associated with another cluster.

13. The data structure of claim 9, wherein a system for synchronizing the transmission of the data uses the data structure to reduce the amount of the data that is lost by improving synchronization performed by a timing recovery loop.

14. The data structure of claim 9, wherein the joint detector only uses the states that survive based on an accumulative metric as parents for generating states for a subsequent sample of data.

15. The system of claim 14, wherein the joint detector uses a list-survivors forward-only algorithm.

16. The system of claim 9, wherein the joint detector uses a forward-only algorithm.

17. A system for handling synchronization errors potentially experienced by a storage device, the system comprising:
a joint detector that detects transmitted data and timing errors that potentially result from the transmission of the data; and
a decoder, wherein the joint detector communicates information about the transmitted data and the timing errors with the decoder iteratively in a loop to reduce an amount of the transmitted data that is lost, wherein the joint detector is a forward-only detector and wherein a trellis is used to represent the information about the transmitted data and the timing errors.

18. The system of claim 17, wherein the system stores most recent hard decision values, soft reliability for most recent bits of data transmitted, accumulative metric values for each state of the timing errors, and most likely number of received samples within a bit interval of data.

19. The system of claim 17, wherein the joint detector uses a list-survivors forward-only algorithm and wherein the joint detector only uses the states that survive based on an accumulative metric as parents for generating states for a subsequent sample of data.

20. The system of claim 19, wherein the system stores a set of surviving states for a cluster of timing errors for a particular piece of data, wherein the surviving states are the parents for generating the states for the subsequent sample of data.

21. A system for handling synchronization errors experienced by a storage device, the system comprising:
a joint detector that detects transmitted data and timing errors that potentially result from the transmission of the data; and
a decoder, wherein the joint detector communicates information about the transmitted data and the timing errors with the decoder iteratively in a loop to reduce an amount of the transmitted data that is lost, wherein the joint detector is a forward-only detector and wherein a trellis is used to represent the information about the transmitted data and the timing errors.

22. The system of claim 21, wherein the system stores most recent hard decision values, soft reliability for most recent bits of data transmitted, accumulative metric values for each state of the timing errors, and most likely number of received samples within a bit interval of data.

23. The system of claim 21, wherein the joint detector uses a list-survivors forward-only algorithm and wherein the joint detector only uses the states that survive based on an accumulative metric as parents for generating states for a subsequent sample of data.

24. The system of claim 23, wherein the system stores a set of surviving states for a cluster of timing errors for a particular piece of data, wherein the surviving states are the parents for generating the states for the subsequent sample of data.
